(19) United States
(12) Patent Application Publication
(10) Pub. No.: US 2002/0143561 A1
(43) Pub. Date: Oct. 3, 2002

(54) Method and system for ordering and tracking services using the internet

(76) Inventor: David D. Sanders, Alvin, TX (US)

Correspondence Address: Terril G. Lewis, Howrey Simon Arnold & White, LLP, 750 Bering Drive, Houston, TX, 77057-2198, US

(21) Appl. No.: 09/822,631

(22) Filed: Mar. 30, 2001

(51) Int. Cl. G06F 17/60

(52) U.S. Cl. 705/1; 705/26

(57) ABSTRACT

A system for a customer to order service of an item and to track the service using the Internet is disclosed. The customer accesses a website hosted by the servicing company to open an account by submitting account data, which is stored. The system then automatically generates an account confirmation e-mail message to the customer using at least a portion of the account data. Thereafter, the customer and submits a service order by submitting order data, which is stored. The system automatically generates an order confirmation e-mail using at least a portion of the order data. The item to be serviced is then sent to the servicing company, which performs the service. Thereafter, the servicing company submits update data relating to the serviced item, which is stored. The system then automatically generates an update confirmation e-mail using at least a portion of the update data.

### FIELD OF THE INVENTION

The present invention relates generally to a method and system for ordering and tracking services for a customer over a network and, more particularly to a method and system for a customer to order service for an item and to track the service using the Internet.

### BACKGROUND OF THE INVENTION

When handling items for repairs, service or testing, companies receive numerous inquiries from customers regarding the status of their service orders. Customers typically inquire on the receipt of the item by the service company and also inquire on the progress of the service on the item. For example, in the calibration industry, customers send measurement devices, such as oscilloscopes, to a calibration service company for testing and repair. At any given time, the company may have numerous service orders for devices being delivered, tested, repaired or returned. Many of the service orders may involve similar models and the same manufacturer.

To track the service orders and inquiries for the customers, the service company may establish a computer system to store information and answer the customer's inquiries. Typically, to handle customer inquiries, the service company may use a service relations department. In the past, the service relations department used telephones or mail systems to handle inquiries. With the advent of computer networks, and especially the Internet, service companies can more readily handle service inquiries without hiring numerous employees or incurring related costs.

Still, much of the handling of the information and responses to customers' inquiries must still be performed manually. The data relating to the service orders may require manual entry or manipulation by service personnel. Therefore, it is desirable to streamline the handling and tracking of service orders. Automating certain activities can proactively mitigate customer inquiries about the status of service orders. Moreover, automation can reduce errors and costs associated with handling the service orders.

The present invention is directed to overcoming, or at least reducing the effects of, one or more of the problems set forth above.

### SUMMARY OF THE INVENTION

In view of the foregoing and other considerations, the present invention relates to a system for a customer to order service of an item and to track the service using the Internet. The customer accesses a website hosted by the servicing company to open an account by submitting account data, which is stored. The system then automatically generates an account confirmation e-mail message to the customer using at least a portion of the account data. Thereafter, the customer and submits a service order by submitting order data, which is stored. The system automatically generates an order confirmation e-mail using at least a portion of the order data. The item to be serviced is then sent to the servicing company, which performs the service. Thereafter, the servicing company submits update data relating to the serviced item, which is stored. The system then automatically generates an update confirmation e-mail using at least a portion of the update data. This automated system greatly simplifies the manual inputting of data by the servicing company and the paper work that it would otherwise have to generate, thus saving time and money. Moreover, because the inputted data is stored and re-used often by the system, the chances of an inadvertent data error are reduced.

The above summary of the present invention is not intended to represent each embodiment, or every aspect of the present invention. This is the purpose of the figures and detailed description that follows.

### BRIEF DESCRIPTION OF THE DRAWINGS

The foregoing, a preferred embodiment and other aspects of the present invention will be best understood with reference to a detailed description of specific embodiments of the invention, which follows, when read in conjunction with the accompanying drawings, in which:

FIG. 1 illustrates a schematic diagram of a method for ordering and tracking service orders for a customer using a communication network;

FIG. 2A illustrates a schematic embodiment of a communication network between a customer and a service company;

FIG. 2B illustrates a schematic embodiment of a computer system used by the customer and the service company;

FIGS. 3A-B illustrate flowcharts of the method for ordering and tracking services for a customer using the Internet;

FIG. 4 illustrates an embodiment of a web page for setting up an online account;

FIGS. 5A-C illustrate embodiments of web pages for ordering services over the Internet; and

FIG. 6 illustrates an embodiment of a web page for updating a customer's service order.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the scope of the invention as defined by the appended claims.

### DETAILED DESCRIPTION OF THE INVENTION

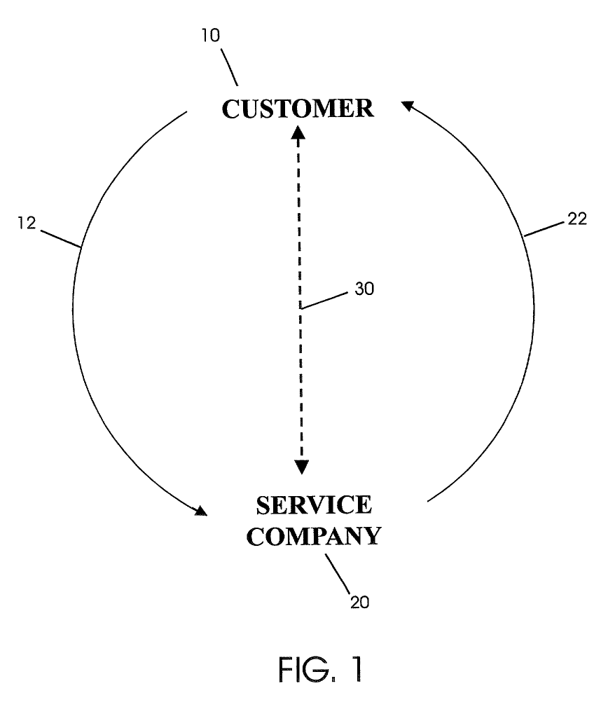

Illustrative embodiments will now be described with reference to the accompanying drawings. Turning to FIG. 1, a schematic diagram generally illustrates the method for ordering and tracking services for a customer 10 using a communication network 30. The customer 10 requires services of an item from a service company 20 and establishes communication with the service company using the communication network 30. Using the communication network 30, the customer 10 uses a computer and provides account information to the service company 20, such as company name, contact information, an network address, a payment method and a shipping method. The customer 10 also orders a particular service from the service company 20 over the communication network 30.

The service company 20, in turn, receives the account information and service order from the customer 10 using the communication network 30. The service company 20 records the customer's information and service order in a computer database. With the service order created, the customer 10 then sends the item for service using a standard delivery means 12, such as the U.S Postal Service, Federal Express® or United Parcel Service®. The service company 20 receives the item and communicates receipt of the item to the customer 10 using the communication network 30 and the customer's network address.

The service company 20 then performs service on the item. Once the service is completed, the service company 20 notifies the customer 10 of the completed service using the communication network 30. In turn, the customer 10 receives prompt notification of the status of their service orders. The service company 20 tracks the progress of the service order and notifies the customer 10. Consequently, the service company is not inundated by status requests on particular orders.

The customer 10 provides all the necessary information to complete the transaction, meaning that the service company need not perform tedious data entry.

Moreover, the information provided by the customer is stored and re-accessed during the handling of the service order. This allows for accurate execution of the customer's service order. The service company 20 uses the address and contact information provided by the customer to return the item. In addition, the service company 20 uses the payment method and information provided by the customer to charge for the service. Finally, the service company 20 returns the item to customer using a shipping method 22 specified by the customer 10.

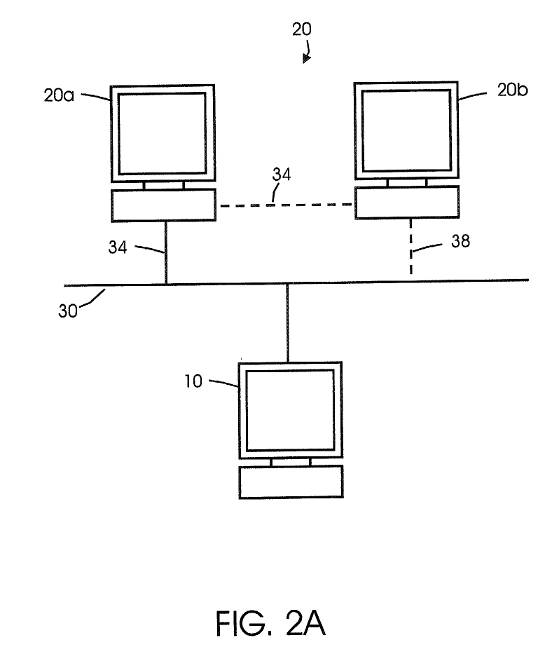

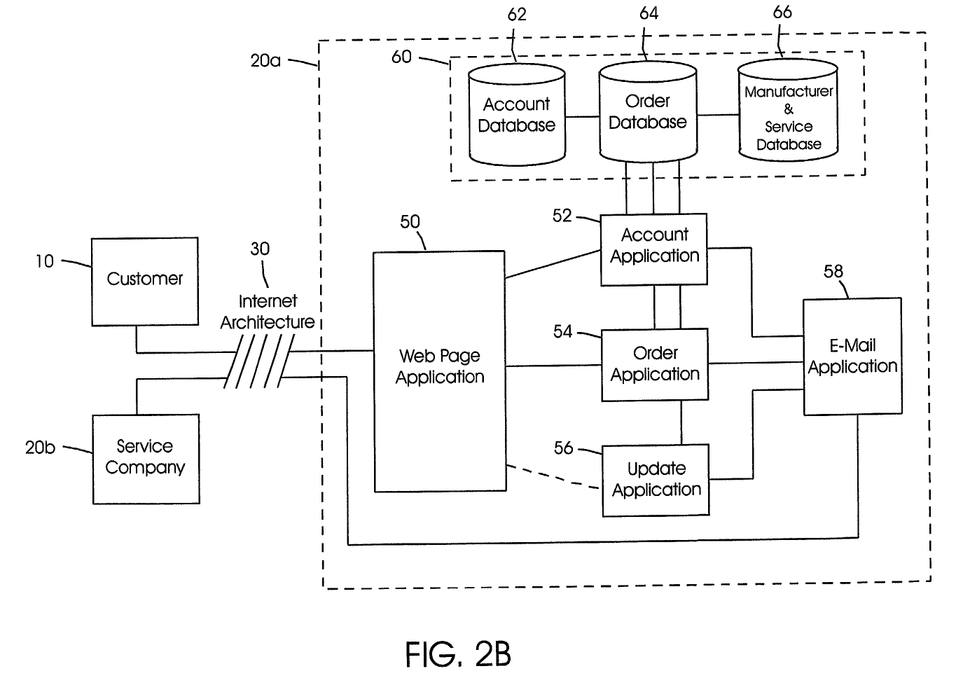

Referring now to FIG. 2A, a schematic embodiment illustrates a communication network 30 between a customer and a service company. The service company uses a computer system 20 having a server 20a and a workstation or remote computer 20b. The present invention is preferably implemented as a computer program running on the server 20a connected to the communication network 30. A preferred communication network 30 for implementing the present invention is the Internet, although the network may also be a local area network or other wide area network.

The computer program on the server 20a includes a network-based application that handles a service company's website on the Internet. The network-based application uses a graphical user interface (GUI) to receive and display information via the Internet. The computer program on the server 20a also includes a plurality of applications for formatting, compiling and storing information on the server 20a. The server 20a includes a plurality of databases for storing information, such as account information, service orders and data for the web page, among other information.

The Internet 30 is accessible by a potential or existing customer through the customer's computer 10. The customer connects 32 to the Internet 30 using their computer 10 and an Internet service company. Through the Internet 30, the customer can gain access to the service company's web page hosted on the server 20a. The customer may review information and services of the service company 20 on the website handled by the server 20a. The customer may input information and order services through a plurality of web pages. The server 20a, in turn, operates the website and stores the information and service orders in databases.

The service company accesses the information and service orders on the server 20a using the workstation or remote computer 20b. The computer 20b may directly connect with the server 20a via a private network connection 36. Because many companies use a separate firm to host their websites, the service company may access the server 20a via an Internet connection 38. However, in a preferred embodiment, the service company's computer 20b communicates with the customer's computer 10 through the server 20a. Communication between the customer's computer 10 and the service company's computer 20b involves the use of information on the server 20a and the use of e-mails over the Internet 30.

Referring now to FIG. 2B, a schematic diagram of an embodiment of a computer system 20a is illustrated. The computer system 20a is preferably implemented as computer software running on a computer, such as a server. The computer system 20a is connected to the Internet architecture 30 so that the customer and the service company may gain access to the computer system 20a using outside terminals or computers 10, 20b. The software implemented on the computer system 20a has a plurality of routines, functions or applications 50-58 and includes a plurality of databases 60. The applications 50-58 include a network-based application 50, an account application 52, an order application 54, an update application 56 and an e-mail application 58. The databases include an account database 62, an order database 64 and a manufacturer and services database 66. Although shown separately, one skilled in the art will recognize that databases 62, 64 and 66 could be combined in one database having separate “account,”“order,” and “update” sections.

As noted above, the computer system 20a includes a network-based application 50 for inputting and outputting data across a network. In the present embodiment, the network-based application 50 defines a data input/output system using web pages with a GUI environment on an Internet website. The web page application 50 receives and displays data and information. The web page application 50 has web pages that provide information about the service company and details regarding the particular services offered. The web page application 50 also has web pages for the entry of account data and service order data from the customer's computer 10.

In particular, the web page application 50 calls on an account application 52 when a customer enters account information via the Internet. The account application 52, in turn, stores information provided by the customer in an account database 62. The web page application 50 also calls on an order application 54 when a customer enters a service order via the Internet. The order application 52 allows the customer to create a service order using the Internet and web pages. When called upon, the order application 54, in turn, reads information from the account database 62 and the manufacturer and service database 66. The order application 54 reads and writes information in an order database 64.

The web page application 50 further calls on an update application 56 when service company personnel enter update information on a service order. The update application 56 allows the service personnel to modify or respond to information of a service order. The computer system 20a may include additional applications for access by the service personnel besides the update application 56. Of course, passwords and other means may restrict access to the update application 56 to qualified service personnel only. When called upon, the update application 56, in turn, reads information from the account database 62 and read/writes information in the order database 64.

The computer system 20a further includes an e-mail application 58, which interacts with the account application 52, the order application 54 and the update application 56. The e-mail application 58 is called upon to generate e-mail messages for the applications 52-56 and automatically generates messages without the need for additional data entry from service personnel.

In particular, the account application 52 calls on the e-mail application 58 to automatically generate an account confirmation e-mail when the customer properly enters account information. The e-mail application 58 compiles and formats information entered into the account database 62 to construct the account confirmation. Additionally, the order application 54 calls on the e-mail application 58 to automatically generate a service order confirmation e-mail when the customer orders a service. The e-mail application 58 compiles and formats information entered into the account database 62 and the order database 64 to construct the service order confirmation. Also, the update application 56 calls on the e-mail application 58 to automatically generate an status e-mail when service company personnel updates the status of a service order. The e-mail application 58 compiles and formats customer information from the account database 62, service order information from the order database 64 and updated information from the update application 56 to construct the status e-mail.

Once the e-mail application 58 composes the relevant account confirmation, order confirmation or status e-mails, connection to the Internet architecture 30 is made. The e-mail application 58 forwards the e-mail to the e-mail address of the customer. In this way, the e-mail application 58 allows for automatically transmitting the e-mails via the Internet architecture 30.

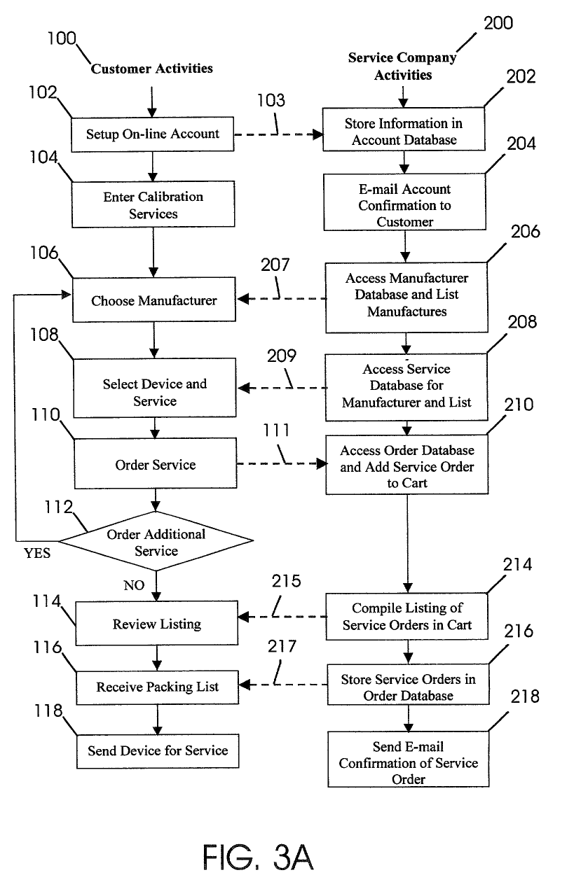

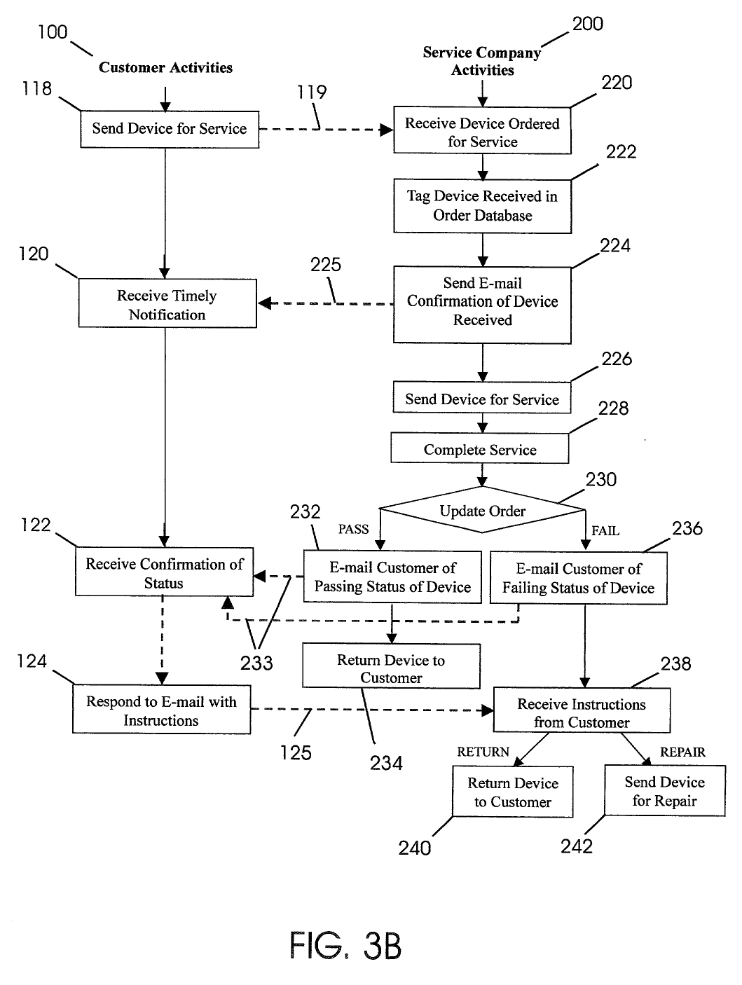

With the schematic descriptions described above, the flowcharts of FIGS. 3A-B further illustrate the method for ordering and tracking services for a customer using the Internet. FIG. 3A illustrates a flowchart showing the interaction between a customer and a service company when ordering and tracking services according to the present invention. To illustrate their interaction, the customer activities 100 are juxtaposed with the service company activities 200.

The discussion following herein provides an example scenario for the services requested by the customer and provided by the service company. The example scenario is not intended to limit the application of the method and system according to the present invention, but is only intended to clearly describe their application to a particular industry. For example, the customer may require service of an item, such as a measurement device. The measurement device may be an oscilloscope or multimeter, which requires calibration, testing or repair. The service company, in this particular example, may be a company in the calibration industry that provides calibration, testing and repair of measurement devices.

In the discussion that follows herein, some of the service company activities 200 are performed by a server that controls the company's website, such as 20a in FIG. 2B. Some of the activities 200 are performed by service company personnel using a computer system connected to the server, such as 20b in FIG. 2B. Additionally, some of the customer activities 100 are performed on a separate computer system accessing the service company's website via the Internet, such as 10 in FIG. 2B. Some of the activities 100 are manually performed using standard delivery means. To simplify the discussion below, the customer activities 100 and service company activities 200 involving manually performed actions will be specifically noted.

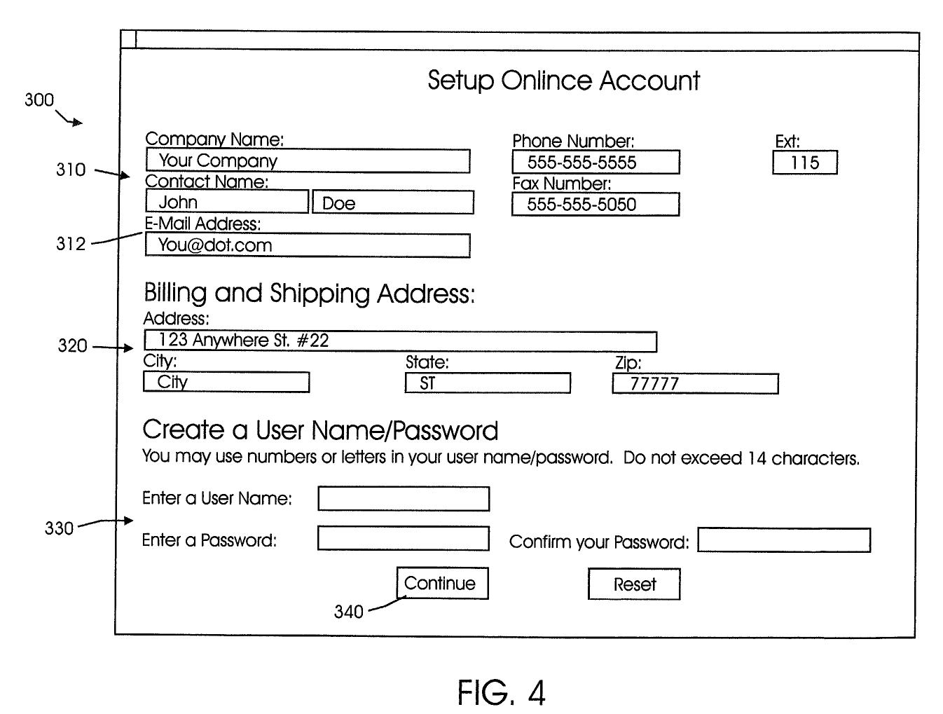

The customer accesses the service company's website via the Internet. Navigating through the website, the customer sets up an online account (Block 102). To establish the account, the customer provides information to the service company, which is entered on a web page. Turning to FIG. 4, web page 300 illustrates an exemplary web page for setting up an online account. The web page 300 includes data fields for inputting customer information. The data fields include, for example: company information 310, an e-mail address 312, a billing and shipping address 320, and a user name and password 330. The customer enters the company information 310 by filling in the company name, telephone numbers and contact name. The e-mail address 312 is also entered in the appropriate field and represents an important aspect of the customer information, as it is used in further communication between the service company and the customer via the Internet.

The customer enters its physical address 320 so that the service company may know where to send bills or return the customer's device once testing, calibration or repair has been completed. Finally, the customer creates a user name and password 330 to secure access to their account information and service orders in the future. By clicking the “Continue” button 340, the information is given to the service company's computer system, which activates the appropriate application and databases to store the information.

Returning to FIG. 3A, the account information described above passes to the computer system 20a (Line 103). The computer system 20a stores the information in an account database (Block 202). An e-mail confirming the account information is then sent to the customer via the Internet (Block 204). The computer system 20a uses the Internet address and possibly other account information provided by the customer and automatically reconfigures the account information into a confirmation account e-mail, which is forwarded to the customer's e-mail address. Sending the e-mail confirms the account information provided by the customer and further verifies proper entry of the customer's e-mail address that will be used in later communications.

With an account established, the customer may enter the area on the website offering calibration services (Block 104). The computer system 20a accesses a database of manufactures for which services are provided (Block 206) and lists the manufactures for the customer to view on a web page (Line 207). The customer then chooses a manufacturer for the device that they wish to be calibrated, tested or repaired (Block 106).

The computer system 20a then accesses a manufacturer and services database having the specific services provided for the manufacture chosen by the customer (Block 208). The program lists the devices and services for the customer to choose (Line 209). For example, if the customer has chosen Hewlett Packard as the manufacturer, the computer system 20a will show a list of Hewlett Packard devices for which calibration, testing and repair service are provided. The customer selects the device and service they wish to have performed by the service company (Block 108) and orders the service by completing a web page (Block 110).

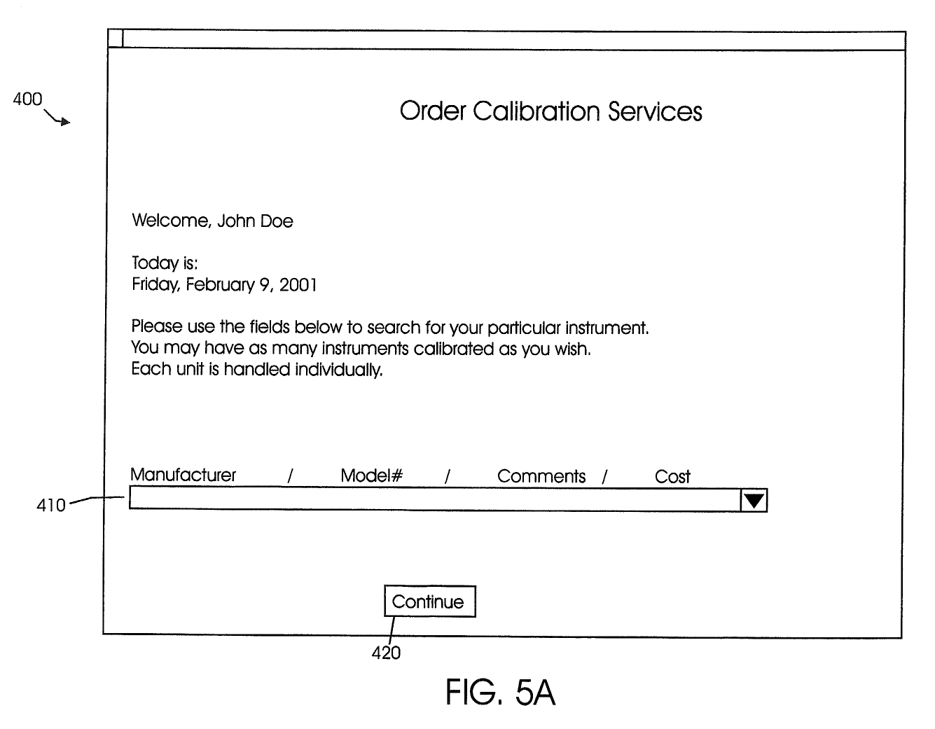

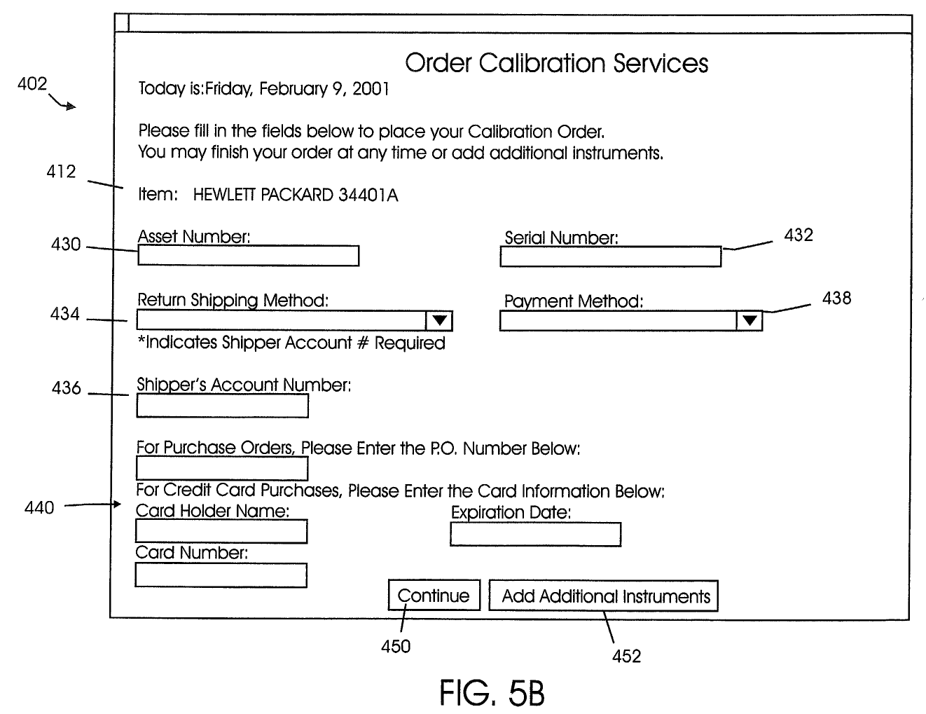

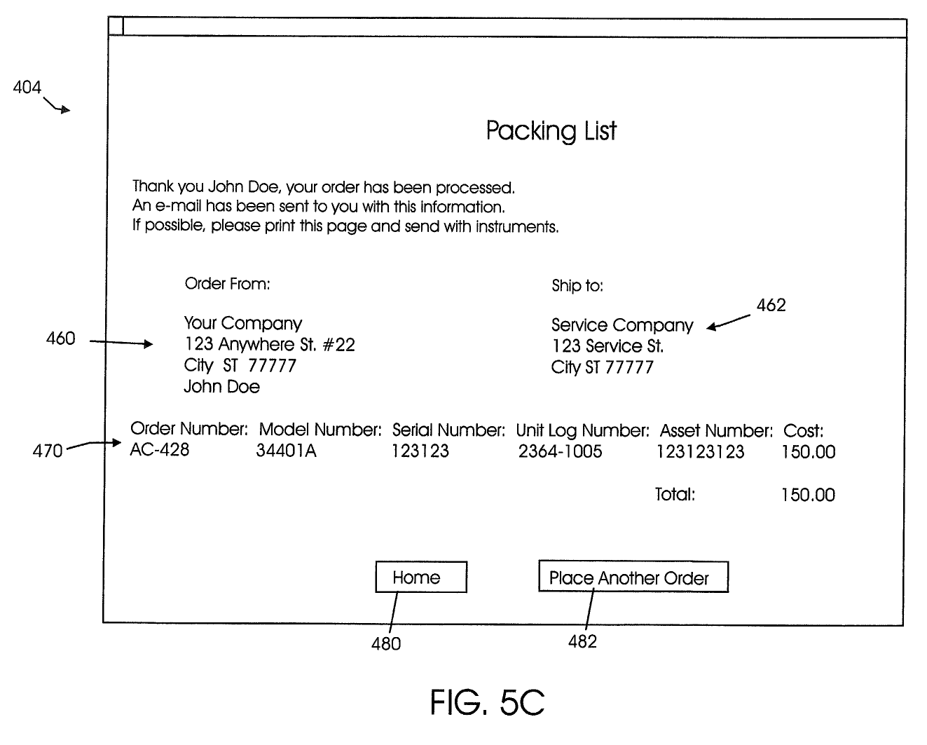

Turning to FIG. 5A, web page 400 illustrates an embodiment of a web page for the customer to order calibration services. The web page 400 includes instructions for the customer and a drop down box 410. The drop down box 410 lists the manufacture's models for which services are provided. The box 410 further includes a description of the service for each device and the associated cost. The customer selects the device for which they require services and clicks the “Continue” button 420.

By choosing the device, the computer system 20a presents another web page for the customer to detail their service order. Turning to FIG. 5B, web page 402 illustrates an embodiment of a web page for detailing a service order. The web page 402 reuses previously input information 412 and includes data fields for new information 430-440. The web page 402 reiterates the description of the device and service chosen on the web page 400 of FIG. 5A. In the present example, the customer is requesting calibration of a Hewlett Packard 34401A multimeter.

The new information includes further description of the device 430, 432, shipping information 434, and billing information 440-444. A data field 430 for an asset number is provided, in which the customer can put a specific number for their own reference. A data field 432 for the device's serial number is also provided. The serial number allows for proper receipt and tracking of the device by the service company.

Using another drop down box 434, the customer selects a return shipping method for the device to be used when the testing or repairs are completed. The return shipping method may include, for example, using Federal Express® or United Parcel Service®. Some of the shipping methods require entry of the customer's shipping account number.

Accordingly, a data field 436 provides for entry of the shipper's account number to be used in charging for the delivery method chosen.

Another drop down box 438 provides payment methods where the customer elects how they will pay for the selected service. The customer fills in the appropriate payment information 440 in either the purchase order field or the credit card fields. Once the customer completes all the information, the customer may continue with the order by clicking a “Continue” button 450 or may add additional devices for service by clicking the button 452.

Returning to FIG. 3A, after the customer has ordered the service for the device (Block 110), their choice is submitted to the computer system 20a of the service company (Line 111). The computer system 20a accesses a database for orders and adds the service order to the customer's cart, which provides temporary storage of the customer's service orders while they navigate through the website. The computer system 20a assigns an account number for each device for which services are ordered, which is used for further is tracking and confirmation purposes (Block 210). The customer can then add additional devices to their cart (Block 112). If additional services are requested, the customer makes the appropriate selections and provides information (Blocks 106-110) and the computer system 20a access the appropriate databases and adds the order to the customers cart (Blocks 206-210).

Once all of the selections are made, the computer system 20a compiles a listing of the devices for which services are ordered in the customer's cart (Block 214). The listing is presented on a review web page (Line 215). The customer reviews the list of ordered services and can individually delete or accept the orders (Block 114). Upon acceptance of the orders, the computer system 20a stores the selected service orders in an order database (Block 216).

The selected orders are then presented to the customer on a confirmation web page (Line 217). The customer can produce a packing list by printing the confirmed orders on the confirmation web page in order to (Block 116). Turning to FIG. 5C, web page 404 illustrates a confirmation web page for printing a packing list. The packing list includes the return address of the customer 460, the mailing address of the service company 462 and the service orders for the selected devices 470. The customer information 460 comes directly form the account database, and the order information 470 comes from the order database. The packing list may be printed and packed with the devices when physically shipped to the service company. The packing list further provides for proper delivery and handling of the items in the service orders.

Returning once again to FIG. 3A, after ordering services and receiving confirmation, the customer sends the items to the service company using a standard shipping method (Block 118). Meanwhile, the computer system 20a of the company automatically sends a confirmation order e-mail to the customer's e-mail address reconfirming the service orders (Block 218) by reconfiguring the relevant data in the order database 64, although inclusion of relevant information from the account database 62 is contemplated for completeness. The confirmation e-mail further ensures the customer that the service company has correctly recorded their service orders.

Referring now to FIG. 3B, a flowchart illustrates the interaction between the customer and the service company when tracking and reporting services according to the present invention. Once again, the customer activities 100 are juxtaposed with the service company activities 200. The customer physically sends the device to the service company (Block 118). The device is forwarded to the service company via conventional delivery means (Line 119). The service company receives the device for which services are ordered (Block 220). Proper receipt can be confirmed by the packing list included in the shipment, by the serial number on the device, and by the account number indicated on the order. Use of the packing list is not strictly necessary as proper receipt of the item may also be confirmed by the service company using computer system 20a.

Upon receipt of the device, service company personnel then flags the device as received in the order database of the computer system 20a (Block 222). By flagging the device as received, the computer system 20a accesses the account information of the customer. The computer system 20a obtains the customer's e-mail address and contact information and automatically sends an e-mail to the customer confirming receipt of the device (Block 224). In producing the e-mail, the service company personnel need not enter contact information or service order information. The computer system 20a automatically and preferably compiles the information from the account database and the order database and forwards the e-mail to the customer's e-mail address (Line 225). Of course, it may not be strictly necessary to query the order data and account data, and the receipt data itself may be utilized in creating the e-mail. The customer receives the confirmation and is timely notified of the handling of the service order (Block 120). Sending the e-mail of the receipt of the device offers certainty in handling the service order. The customer is promptly notified whether the device has been properly delivered to the service company.

The service company then submits the device for calibration, testing or repair, depending on the services ordered by the customer (Block 226). Once the servicing is completed on the device (Block 228), the service personnel then access the computer system 20a to update the order (Block 230). Updating the order may also involve indicating various stages of completion of the services. For example, the service personnel may update the order by indicating whether the device has either failed or passed a testing service.

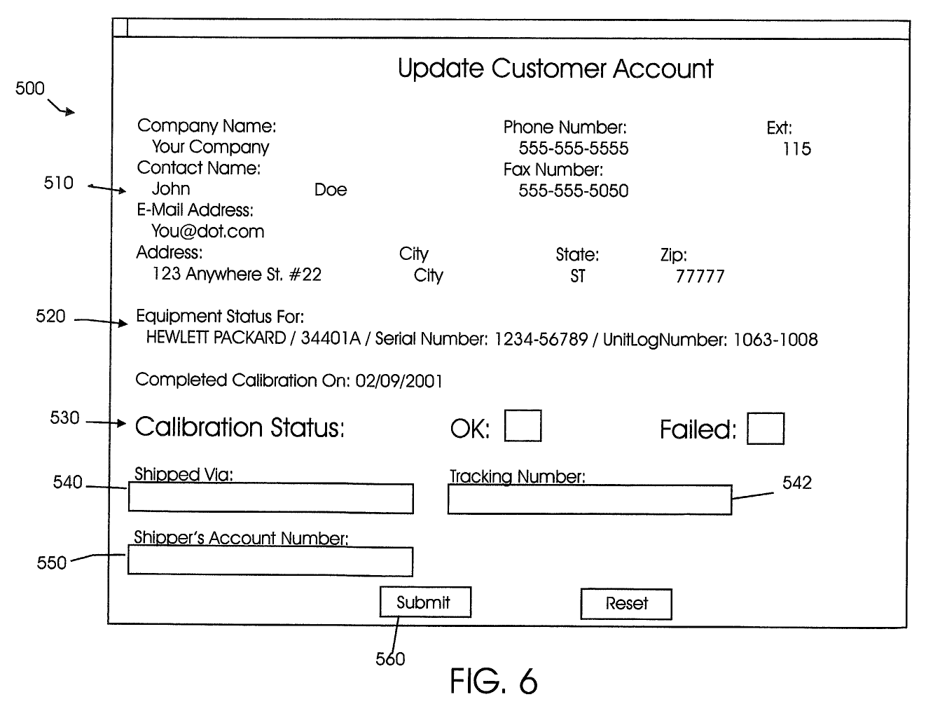

Turning to FIG. 6, web page 500 illustrates an embodiment of a web page for updating the customer service order. The service personnel access the computer system 20a to update the service order. The web page 500 includes fields for previously input information 510, 520, 540 and 550. These fields are automatically populated with the appropriate information drawn from the account database and the order database. The update screen 500 includes the customer account information 510 obtained from the account database and a description of the service chosen 520 obtained from the order database. The web page 500 also includes the shipping method 540 and customer shipping number 550 obtained from the order database.

The update screen also includes data fields for new information 530, 542, which will be stored in the update database 66. The new information includes the status of the calibration of the device 530 and the tracking number for returning the device 542. The service personnel updates the status of the testing service by clicking either “OK” or “Failed”. Of course, more detailed information regarding the servicing could be included. For example, the status 530 could constitute or incorporate a test box wherein the service personnel could draft a short report to the customer, perhaps notifying the customer of certain parts that need to be ordered. If the device has passed, the service personnel may enter the tracking number 542 for returning the device via a standard delivery means that uses tracking. The tracking number 542 relates to the reference number of the shipping service. For example, both Federal Express® and United Parcel Service® have Internet websites where the customer and service personnel can track the shipment of the device using the tracking number 542.

The service personnel completes the update of the service order by clicking a “Submit” button 560. The computer system 20a automatically constructs an update email notification preferably by accessing the relevant data in the account, order, and update databases 62, 64, and 66, although it is contemplated that only the update data may be necessary. The e-mail is then forwarded to the customer's e-mail address. The notification indicates the result of the testing service for the device. Separate updates are made on each device so that e-mails are sent for each device. Each of the e-mails indicates whether the particular device has either passed or failed the selected testing service or may also contain a short report as mentioned above. Sending the e-mail notification provides the customer with information they will need in deciding whether to have the device returned or repaired.

Returning to FIG. 3B, updating the device as passing the test on the service order automatically generates an e-mail of the passing status of the device (Block 232). The e-mail is then automatically sent to the e-mail address of the customer (Line 233). The customer receives the notification of the status through their e-mail address (Block 122). The service company personnel need only flag the device as passing the test in order to send the e-mail notification to the customer. The computer system 20a utilizes a pre-configured e-mail compiling information from the account database and order database. After notifying the customer of the passing test, the device is then returned to the customer. The return shipping method and payment method for completing the service order comes directly from the order database.

By updating the device as failing the testing service on the service order, an email of the failing status of the device is automatically generated (Block 236) and sent to the customer (Line 233). The customer receives the notification of the status through their e-mail address (Block 122). Again, the service company personnel need only flag the device as failing in order to send the e-mail notification to the customer. The computer system 20a utilizes a pre-configured e-mail compiling information from the account database and order database. The customer may then respond to the e-mail notification of the failing test result (Block 124). The customer may decide to have the defective device returned or have the device repaired and recalibrated. The customer replies to the e-mail and provides their instructions for the defective device (Line 125). Based on the customer's instruction, the device is returned to the customer (Block 240) or sent for repairs (Block 242).

While the invention has been described with reference to the preferred embodiments, obvious modifications and alterations are possible by those skilled in the related art. Therefore, it is intended that the invention include all such modifications and alterations to the full extent that they come within the scope of the following claims or the equivalents thereof.

What is claimed is:

1. A method for processing an order from a customer relating to an item to be serviced by a servicer, the method implementable on a service computer connected to a computer network, the method comprising the steps of:
a) receiving order data from the customer across the computer network, the order data including information concerning the item to be serviced;
b) automatically generating an order confirmation message to a network address of the customer using at least a portion of the order data;
c) receiving update data from the servicer concerning the serviced item across the computer network; and
d) automatically generating an update confirmation message to the customer's network address using at least a portion of the update data.

2. The method of claim 1, further comprising the steps of:
e) receiving account data from the customer across the computer network; and
f) automatically generating an account confirmation message to the customer's network address using at least a portion of the account data.

3. The method of claim 1, wherein the step (d) comprises using at least a portion of the order data and at least a portion of the update data.

4. The method of claim 2, wherein step (b) comprises using at least a portion of the account data and at least a portion of the order data.

5. The method of claim 2, wherein step (d) comprises using at least a portion of the account data, at least a portion of the order data, and at least a portion of the update data.

6. The method of claim 1, further comprising the steps of:
e) receiving data from the servicer indicative of receipt of the item; and
f) automatically generating a receipt confirmation message to the customer network address using at least a portion of the data indicative of receipt of the item.

7. A network based application program for processing an order from a customer relating to an item to be serviced by a servicer, the program implementable on a service computer connected to a computer network, the program comprising:
a) a graphical user interface including
(i) an order input screen for allowing the customer to input order data relating to the item to be serviced thought the computer network; and
(ii) an update input screen for allowing the servicer to input update data relating to the item to be serviced through the computer network; and
b) an electronic mail application, wherein the application
(i) automatically generates an order confirmation message to a network address of the customer address in response to the inputting of order data by using at least a portion of the order data; and
(ii) automatically generates an update confirmation message to the customer's network address in response to the inputting of update data by using at least a portion of the update data.

8. The program of claim 7, wherein
(a) the graphical user interface further includes (iii) an account input screen for allowing the customer to open an account with the servicer; and
(b) the e-mail application further (iii) automatically generates an account confirmation message to the customer's network address in response to the inputting of account data by using at least a portion of the account data.

9. The program of claim 7, wherein the graphical user interface further includes a flag accessible by the servicer that is indicative of whether the item has been received by the servicer.

10. The program of claim 9, wherein the e-mail application further automatically generates a receipt confirmation message to the customer network address in response to accessing the flag.

11. The program of claim 7, wherein the order input screen contains at least one menu providing options corresponding to at least a portion of the order data.

12. The program of claim 7, wherein the update input screen contains at least one menu providing options corresponding to at least a portion of the update data.

13. The program of claim 8, wherein the account input screen contains at least one menu providing options corresponding to at least a portion of the account data.

14. The program of claim 8, wherein the e-mail application automatically generates an order confirmation message to the customer's network address by using at least a portion of the account data and at least a portion of the order update data.

15. The program of claim 8, wherein the e-mail application automatically generates an update confirmation message to the customer's network address by using at least a portion of the account data, at least a portion of the order update data, and at least a portion of the update data.

16. A method for processing an order from a customer relating to an item to be serviced by a servicer, the method implementable by an application program running on a service computer connected to a computer network, the method comprising the steps of:
(a) accessing the application program through the network by the customer to input order data concerning the item to be serviced;
(b) accessing the application program through the network by the servicer to input receipt data upon receiving the item to be serviced;
(c) accessing the application program through the network by the servicer to input update data concerning the item to be serviced; and
(d) automatically sending an electronic mail message to the customer in response to steps (a), (b), and (c) to confirm completion of those steps.

17. The method of claim 16, wherein steps (a), (b), and (c) are performed through a graphical user interface provided by the application program.

18. The method of claim 16, further comprising accessing the application through the network by the customer to input account data to allow the customer to open an account.

19. The method of claim 18, wherein the application program provides menus providing selectable options corresponding to the account data, the order data, and the update data.

20. The method of claim 16, wherein receipt data is a flag.
